(19) United States
(12) Patent Application Publication
(10) Pub. No.: US 2006/0279772 A1
(43) Pub. Date: Dec. 14, 2006

(54) Secure web based system for generating a printed document at a remote printer

(75) Inventors: Keith D. Ludwig, New Fields, NH (US); Gregory E. Park, Stratham, NH (US)

Correspondence Address: TIMOTHY P. O'HAGAN, 8710 KILKENNY CT, FORT MYERS, FL, 33912, US

(73) Assignee: Bottomline Technologies (DE) Inc., Portsmouth, NH (US)

(21) Appl. No.: 11/177,213

(22) Filed: Jul. 7, 2005

Related U.S. Application Data
(63) Continuation-in-part of application No. 11/152,450, filed on Jun. 14, 2005.

(51) Int. Cl. G06F 3/12

(52) U.S. Cl. 358/1.15

(57) ABSTRACT

A system for generating a document at a remote printer includes a print services server, an application server, and a print control executable. The print services server stores a plurality of binary objects each in association with a unique identifier. Each binary object includes a print formatted object representing a document set. The application server: i) establishes a transport session with a browser of a remote client; ii) provides a listing of a plurality of document sets to the remote client; iii) obtains identification of a selected one of the plurality of document sets; and iv) generates a return object instruction message to the print services sever. The return object instruction message including an identification number which corresponds to the unique identifier associated with the binary object that includes the print formatted object representing the selected one of the plurality of document sets. The print services server receives the return object instruction and provides a response. The response includes the corresponding binary object. The print control executable receives the binary object and passes the print formatted object to the remote printer.

### TECHNICAL FIELD

The present invention relates to a system and method for secure document delivery to a remote location, and more particularly, to a secure system and method for generating and passing a print formatted object to a remote print systems.

### BACKGROUND OF THE INVENTION

Businesses have long used software systems for recording their commercial interactions with customers, vendors, financial institutions, and other third parties. Traditionally, transactional information has been exchanged between two businesses using printed documents such as purchase orders, invoices, and other similar documents.

The software systems of a first business generate and print such a document, the document is delivered to the recipient business, and an agent of the recipient business manually enters information from the document into its software systems.

Checks and other negotiable instruments are a special type of transaction document in that its clearing through banking systems result in the transfer of funds from a payor's bank account to a payee's bank account. While no check printing system is entirely “error proof” of “fraud proof”, security has always been an important aspect of the software systems which print checks to reduce erroneous and/or fraudulent check printing.

Early check printing systems received payment information from an accounting system and printed the payment information onto pre-printed check stock. Security in such systems is maintained by: i) controlling access to the blank check stock; and ii) using log-on authentication systems to control access to the software.

More recently developed laser check printing systems and MICR toner enable printing of checks on blank stock. Security in a laser check printing systems is maintained by using log-on authentication systems to control access to the software and encryption of payment data in the databases managed by the laser check printing system. I

In a large business enterprise, it is desirable to be able to control check printing from a single location, such as corporate headquarters, but to enable the physical check documents to be printed at remote locations. This produces security challenges not addressed by known laser check printing and document delivery systems.

First, a portion of a laser check printing system's security exists in that the software which generates the check operates on the same computer on which the print spooler exists. As such, once a print formatted object representing the check is generated, it is transferred directly to the print spooler without ever being saved to the hard drive of the computer. This reduces the ability to accidentally or intentionally reprint the same check document a second time.

A problem with attempting to implement such technology for printing at remote locations requires distribution of the laser check printing software to each remote location, granting access to the software to personal at each location, and transferring payment files to each remote location for the operator to: decrypt the file, load into the check printing software; and initiate local printing of the checks. Such a system fails to maintain centralized control of check printing.

Another potential solution would include using known laser check printing solution to “print” checks at a centralized location to a portable document file rather than to hard copy. Traditional file delivery systems such as email, FTP, and other similar protocols may be used for transferring the portable document file from the computer on which the laser check system is resident to a remote computer system at which the checks can then be printed. This system also has several draw backs. First, traditional file delivery systems such as email and FTP store a copy of the file on the hard drive of the sending computer and on the hard drive of the receiving computer—making such file available for accidental or intentional reprinting of the documents. Adding password access control to each portable document file is cumbersome at best.

U.S. Pat. No. 6,615,234 to Adamske et al. discloses a server based document delivery system which can be used for transferring a document directly to a remote print spooler server over a network. The server of Adamske et al. includes a plurality of software applications. Each software application receives information content in as file in one of a plurality of file formats which the software application is capable of opening. The software application is used to generate an image of a document and the server generates a document file the from for delivery to a print spooler server for printing. The document file delivered to the print spooler is a PostScript file. While such a system could be useful for printing checks on a remote printer, it has drawbacks.

First, to be used for printing checks, the server must have application level software which is capable of opening the electronic file passed from the laser check printing software and “printing” the checks. This can lead cumbersome duplicate installation and duplicate maintenance issues.

Secondly, the timing of when the checks are printed on the remote computer is under the control of the operator transferring the electronic checks to the server and the server generating the Post Script for transfer to the print spooler. As such, security of the printer at the time the checks are to be printed must be coordinated between the operator of the centralized laser check printing software and those with control over the remote printer.

A separate field of technology known as web services is being developed to support platform independent processing calls over the Internet. Web Services are data processing services (referred to as methods) which are offered by a servicing application to a requesting application operating on a remote system.

The system offering the web services to requesting systems publishes a Web Service Description Language (WSDL) document which is an Extensible Markup Language (XML) document in compliance with the WSDL protocol that describes the web service. The description of the web service may include the name of the web service, the tasks that it performs, the URL to which the method requests may be sent, and the XML structure and parameters required in a method request.

To obtain a published service, the requesting application sends a method call to the system as a Simple Object Access Protocol (SOAP) message. The SOAP message includes an XML method call which conforms to the required structure and parameters. So long as each system can build and interpret the SOAP message, no compatibility between the two systems is required.

Web services enable applications to be written which request data from the web service providers. For example, a web server which provides stock quotes may publish the structure and parameters for requesting a stock quote, the method call may be required to include the ticker symbol corresponding to the requested quote. The web server system provides the information to the requesting application in response to receiving such a method call.

The use of web service systems for transferring transaction data between two applications has at least two problems.

First, each of the two applications must be configured to manage the exchange of XML messages at the application level. For example, the client application must be configured with the appropriate information for contacting the web services server and the two applications must be appropriately configured for handling the timing of the transaction transfer and appropriate acknowledgments.

Secondly, web service technology is a transport technology that does not include any inherent security. The transfer of method calls using web services can be secured only if the applications include means for mutual authentication and means for encrypting the messages.

What is needed is a system and method for secure document delivery to a remote location that does not suffer the disadvantages of the known system. More specifically, what is needed is a system and method for the secure transport of a transaction document to a remote system.

### SUMMARY OF THE INVENTION

A first aspect of the present invention is to provide a system for generating a document at a remote print system. The system comprises a secure print services server, an application server, and a print control executable.

The secure print services server comprises a return object and binary storage. The binary storage stores a plurality of binary objects each in association with a unique identifier. Each binary object including a print formatted object (generated by a print object) representing a document set.

The application server comprises a web server and a web services client. The web server establishes a secure transport session with a browser of the remote client and, through the secure transport session: i) provides a listing of a plurality of document sets to a remote client; and ii) obtains identification of a selected one of the plurality of document sets.

The web services client exchanges simple object access protocol (SOAP) messages with the secure print services server. The web services client generates a return object instruction message. The return object instruction message comprises an identification number which corresponds to the unique identification number associated with the binary object that includes the print formatted object representing the selected one of the plurality of document sets.

The return object of the secure print service server: i) receives the return object instruction; and ii) provides a response message to the web services client. The response message includes the binary object that is stored in association with the unique identification number that corresponds to the identification number provided in the return object instruction message.

The print control executable receives the binary object and passes the print formatted object to the remote print system.

The binary object may include an encrypted representation of the print formatted object. The encrypted representation may be the result of encrypting the print formatted object using a predetermined cipher specification which corresponds to a predetermined deciphering specification coded into (or pre-shared with) the print control executable. In which case, the print control executable further decrypts the encrypted representation of the print formatted object to recover the print formatted object into volatile memory only using the predetermined deciphering specification.

In one sub embodiment, the web server may further obtain identification of a selected remote print system to which the print formatted object of the document set is to be transferred. In such sub embodiment: i) the web services client includes identification of the selected remote print system in the return object instruction; ii) the response message further includes identification of the selected remote print system; and iii) the print control executable extracts identification of the selected remote print system from the response message and passes the print formatted object to the selected remote print system.

In another sub embodiment, upon receipt of the binary object, the print control executable may generate a dialog box to obtain user identification of a selected remote print system. Upon receipt of user identification of a selected remote print system, the print control executable asses the print formatted object to the selected remote print system.

In one embodiment, the print control executable may operate on a remote client as a browser extension or plug in. In such embodiment, the return object of the secure document printing services server provides the response message to the web services client and the web server provides the binary object from the response message to the print control executable on the remote client.

In another embodiment, the print control executable may operate on the application server. In such embodiment, the binary object is passed directly from the web services client 105 to the print control executable using known systems for exchanging data between applications operating on the same hardware systems.

For a better understanding of the present invention, together with other and further aspects thereof, reference is made to the following description, taken in conjunction with the accompanying drawings, and its scope will be pointed out in the appended claims.

### BRIEF DESCRIPTION OF THE DRAWINGS

FIG. 1 is a block diagram of a secure web based system for generating a printed document at a remote printer in accordance with one embodiment of the present invention;

FIG. 2a is a block diagram of a secure web based system for generating a printed document at a remote printer in accordance with one embodiment of the present invention;

FIG. 2b is a block diagram of a secure web based system for generating a printed document at a remote printer in accordance with one embodiment of the present invention;

FIG. 3 is a ladder diagram representing operation of a system for generating a printed document at a remote printer in accordance with one embodiment of the present invention;

FIG. 4 is flow chart representing exemplary operation of a print control executable in accordance with one embodiment of the present invention;

FIG. 5 is a block diagram of a secure web based system for generating a printed document at a remote printer in accordance with one embodiment of the present invention;

FIG. 6 is a ladder diagram representing operation of a system for generating a printed document at a remote printer in accordance with one embodiment of the present invention;

FIG. 7 is a diagram representing an exemplary web page for user selection of a document batch for printing in accordance with one embodiment of the present invention; and

FIG. 8 is diagram representing an exemplary document template in accordance with one embodiment of the present invention.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

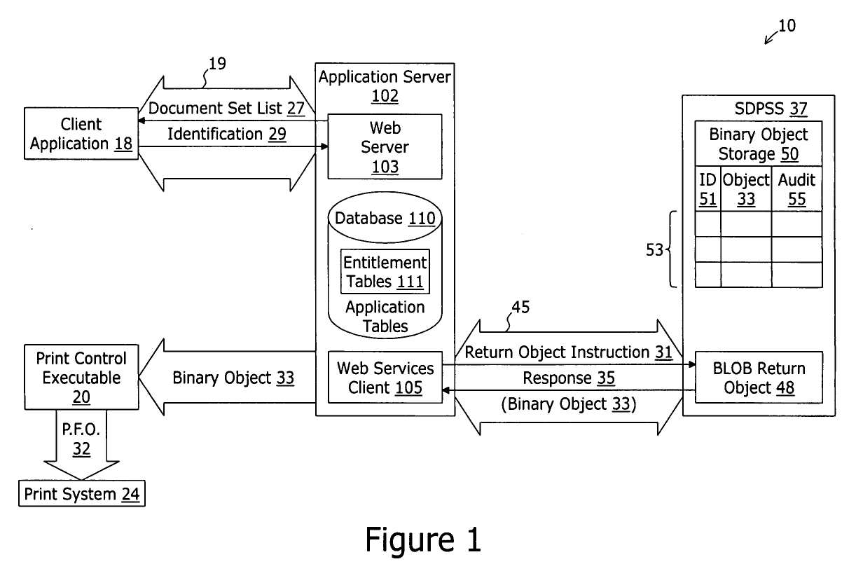

FIG. 1 illustrates exemplary architecture of system 10 providing secure transaction document printing services at a remote print system 24. The system 10 comprises an application server 102, a secure document printing services server 37, and a print control executable 20.

As will be discussed in more detail later, although the block diagram of FIG. 1 shows the print control executable 20 as a block separate from each of the application server 102 and the client application 18, it is envisioned that the print control executable 20 may be a system operated by the application server 102 or may be a system operated in conjunction with the client application 18—for example as a browser plug in.

The secure document printing services server 37 comprises binary object storage 50 and an executable or interpretable binary large object (BLOB) return object 48.

The binary object storage 50 may include a database with a plurality of records 53. Each record 53 stores one of a plurality of binary objects 33 in association with a unique identifier 51.

As will be discussed in more detail herein, each binary object 50 includes a print formatted object 32 representing a document set. The print formatted object 32 may be a Post Script file, a Printer Command Language file, or other print formatted object which includes objects, fonts, and/or graphics in a format useful by the printer system 24 for generating the document set represented by the print formatted object 32.

The application server 102 comprises a web server 103 and a web services client 105. A user of the client application 18 (with document printing entitlements as defined in entitlement tables 111) may initiate a transport session 19 (such as HTTPS session) with the web server 103. Though the transport session 19, the web server 103: i) provides a document set listing 27 to the remote client 18; and ii) obtains identification 29 of a selected one of the plurality of document sets that is approved for printing. More specifically the document set listing 27 may be a web page listing each document set represented by a binary object 22 within object storage 50. Such web page may further include code prompting the user of remote client 18 to select a document set for printing and, following selection, post the identification 29 of the selected one of the plurality of document sets to the web server 103.

The web services client 105 establishes a web services session 45 with the secure document printing services server 37 during which simple object access protocol (SOAP) messages may be exchanged between the web services client 105 and the secure document printing services server 37.

The web services client 105 generates a SOAP message (and sends the SOAP message to the secure document printing services server 37) that includes a return object instruction message 31. The return object instruction message 31 comprises an identification number which corresponds to the unique identification number 51 associated with the binary object 33 (stored in the binary object storage 50) that includes the print formatted object 32 representing the selected one of the plurality of document sets.

The BLOB return object 48: i) receives the return object instruction message 31 and provides a response message 35. The response message 35 includes the binary object 33 that is stored in association with the unique identification number 51 that corresponds to the identification number provided in the return object instruction message 31.

The binary object 33 is then passed to the print control executable 20 (whether operating on the application server 102, coupled to the application server 102 by a network, or operating in conjunction with the client application 18). The print control executable 20 receives the binary object 33, recovers the print formatted object 32, and passes the print formatted object 32 to the remote print system 24.

Further, in an embodiment wherein the print formatted object 32 is encrypted using a predetermined (or pre-shared) cipher specification (e.g. a predetermined ciphering algorithm and a predetermined key), the binary object 33 will include an encrypted representation of the print formatted object 32 and the print control executable 20 will decipher the encrypted representation (using a predetermined deciphering specification which corresponds to the predetermined ciphering specification) into volatile memory only to recover the print formatted object 32. The recovered and deciphered print formatted object 32 is then sent to the remote print system 24.

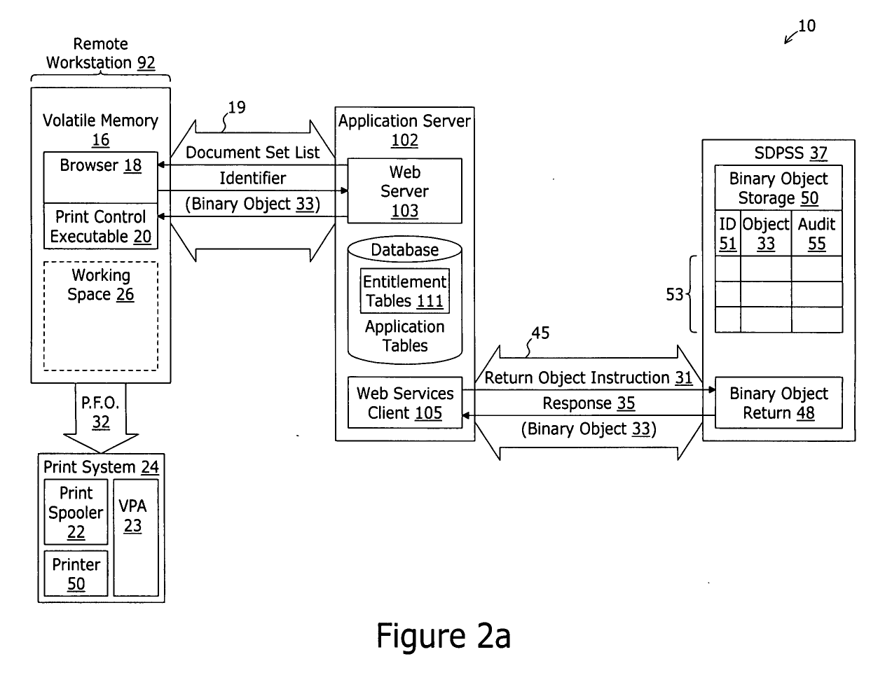

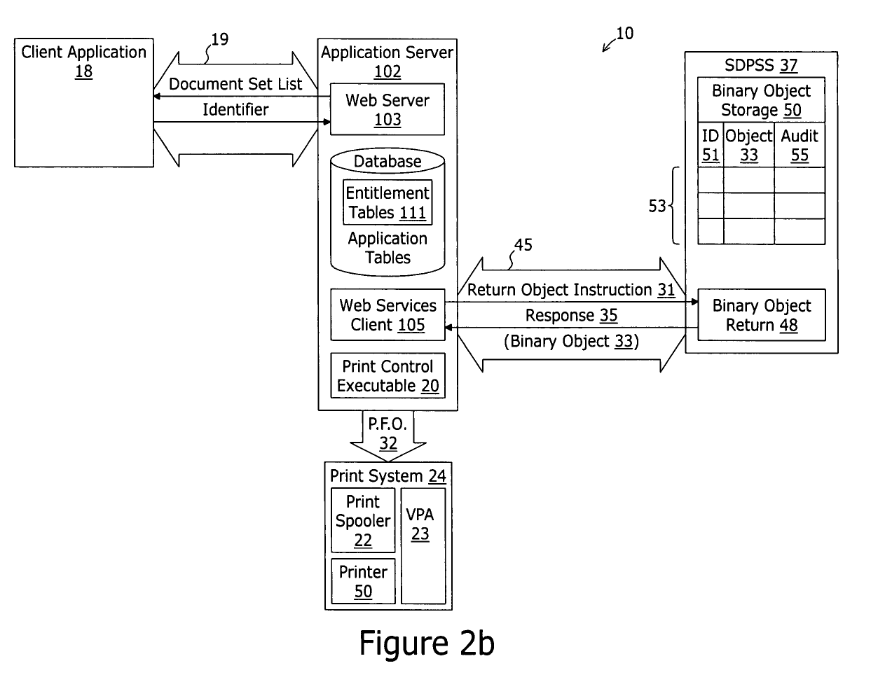

The block diagram of FIG. 2a represents an embodiment wherein the client application 18 is a web browser (e.g. web browser 18) operating on a remote workstation 92, the print control executable 20 is operating in conjunction with the web browser 18 (e.g. as a component of, an extension to, or a plug in to, the web browser 18). Both web browser 18 and the print control executable 20 are code executed from volatile memory 16 of the remote workstation 92. As is known in computer architecture, in addition to storing executable code, the volatile memory 16 stores data being manipulated by the executable code. Working space 26 represents the “address space” of the volatile memory 16 used for storing data being manipulated by the executable code.

In this embodiment, the binary object 33 included in the response message 35 provided to the web services client 105 is passed to the web server 103. The web server 103 provides the binary object 33 to the print control executable 20 through the transport session 19 established between the browser 18 and the web server 103.

The print control executable 20: i) obtains the binary object 33 (as is typical of a browser plug in); ii) recovers the print formatted object 32 into the volatile memory 16 only; and iii) passes the recovered print formatted object 32 to the print system 24 for document generation.

Again, in an embodiment wherein the print formatted object 32 is encrypted using a predetermined (or pre-shared) cipher specification, the print control executable 20 will decipher the encrypted representation into volatile memory only to recover the print formatted object 32 and provide the recovered and deciphered print formatted object 32 to the remote print system 24.

It should be appreciated that by receiving and deciphering the print command file 32 into working space 26 of the volatile memory 16 only, no non-volatile record of the print command file 32 is written to a hard drive or other non-volatile storage thereby reducing the ability to intentionally (or unintentionally) printing the document a second time.

The print system 24 may be a print spooler 22 and a (local or network) printer 50 or a virtual print application 23 such as Acrobat PDF Writer® available from Adobe Systems.

The block diagram of FIG. 2b represents an embodiment wherein the print control executable 20 is operating on the application server 102 (e.g. being executed from volatile memory (not shown) in conjunction with the web server 103 and the web services client 105).

In this embodiment, the binary object 33 included in the response message 35 provided to the web services client 105 is passed directly to the print control executable 20 using known systems for transferring data between processes executing on the same hardware.

The print control executable 20: i) obtains the binary object 33; ii) recovers the print formatted object 32 into the volatile memory only; and iii) passes the recovered print formatted object 32 to the print system 24 for document generation.

Again, in an embodiment wherein the print formatted object 32 is encrypted using a predetermined (or pre-shared) cipher specification, the print control executable 20 will decipher the encrypted representation into volatile memory only to recover the print formatted object 32 and provide the recovered and deciphered print formatted object 32 to the remote print system 24.

Again, it should be appreciated that by receiving and deciphering the print command file 32 into volatile memory only, no non-volatile record of the print command file 32 is written to a hard drive or other non-volatile storage thereby reducing the ability to intentionally (or unintentionally) printing the document a second time.

Again, the print system 24 may be a print spooler 22 and a (local or network) printer 50 or a virtual print application 23 such as Acrobat PDF Writer® available from Adobe Systems.

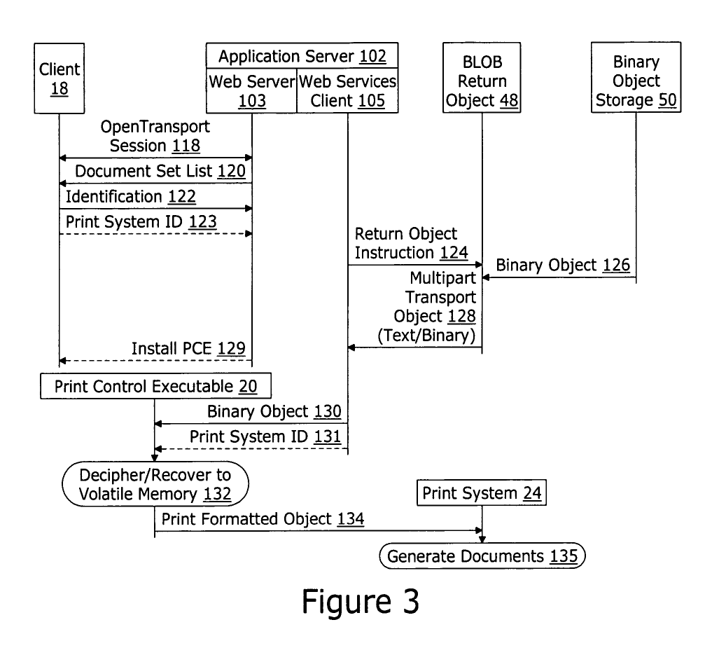

The ladder diagram of FIG. 3 represents exemplary interaction of the client application 18, the application server 102, the BLOB return object 48, and the binary storage 50 for implementing an embodiment of the present invention. Referring to the ladder diagram of FIG. 3 in conjunction with FIG. 1

Step 118 represents the client 18 and the web server 103 opening the secure transport session 19 and verifying the entitlements of the user. As discussed, in the exemplary embodiment the secure transport session 19 is an HTTPS session.

Step 120 represents the web server 102 providing the document set listing 27 to the client application 18. As discussed, the document set listing 27 may be a web page that includes a list of each document set represented by a binary object 22 within object storage 50.

Step 122 represents the client application 18 providing identification 29 of a selected document set back to the web server 103. As discussed, the web page including the document set list 27 may include code prompting the user of the remote client 18 to select a document set for printing and, following selection, post the identification 29 of the selected one of the plurality of document sets to the web server 103. Step 122 represents such posting.

In a sub embodiment wherein the print system 24 at which the document set is to be printed (or virtually printed) is selected by the user of client 18, the web page (or a separate web page or dialog box provided through the transport session 19) may be used to obtain user identification of the selected remote print system at which the document set is to be printed. Step 123 represents obtaining identification of the selected remote print system.

Step 124 represents the web services client providing a return object instruction message 31 to the secure document printing services server 37 and the BLOB return object 48 receiving such instruction message 31.

The return object instruction message 31 may be an XML message within a SOAP wrapper which includes the an identification number which corresponds to the unique identification number 51 associated with the binary object 33 (stored in the binary object storage 50) that includes the print formatted object 32 representing the selected one of the plurality of document sets. As is typical of an XML message, a predetermined text label is used to label or identify such identification number.

Further, in the sub embodiment wherein the print system 24 at which the document set is to be printed is selected by the user of client 18, identification of the selected remote print system may be included in the return object instruction message 31.

Step 126 represents the BLOB return object 48 retrieving the binary object 33 (which corresponds to the identification number provided in the return object instruction message 31) from the binary storage 50.

Step 128 represents the BLOB return object 48 providing a response message 35 back to the web services client 105. As discussed, response message 35 includes the retrieved binary object 33. The response message 35 may be a multipart transport message that includes both a SOAP object within a root body part and the binary object 33. The multipart transport message may comply with the MIME protocol and include the SOAP object within the root body part and include a predetermined text string identifying the type of file represented by the binary object 33.

Step 130 represents sending the binary object 33 to the print control executable 20 and, in the sub embodiment wherein the print system 24 at which the document set is to be printed is selected by the user of client 18, step 131 represents sending identification of the selected remote print system to the print control executable. Both may be sent in the same multipart transport message.

As discussed with respect to FIGS. 1, 2a, and 2b, the print control executable 20 may be a system operated by the application server 102 or may be a system operated in conjunction with the client application 18—for example as a browser plug in.

In an implementation wherein the print control executable 20 operates in conjunction with a browser 18 on a remote client workstation 92 (FIG. 2a), if a binary object 33 representing an encrypted print command file 32 is received and the print control executable 20 is not yet installed on the remote client 92, a print control install file 104 may be provided to the remote workstation 92 and the user prompted to download and install the print control executable 20 in the manner typically for downloading and installing “browser plug-ins”. Step 129 represents downloading a print control installation file and installing the print control executable 20 on the workstation 92-if not previously installed.

Box 132 represents the print control executable 20 recovering (and if applicable, deciphering to recover) the print formatted object 32 and, at step 134, passing the print formatted object 32 to the print system 24. As discussed, the print control executable 20 recovers and deciphers the print formatted object 32 into volatile memory only, no non-volatile record of the print command file 32 is written to a hard drive or other non-volatile storage thereby reducing the ability to intentionally (or unintentionally) printing the document a second time.

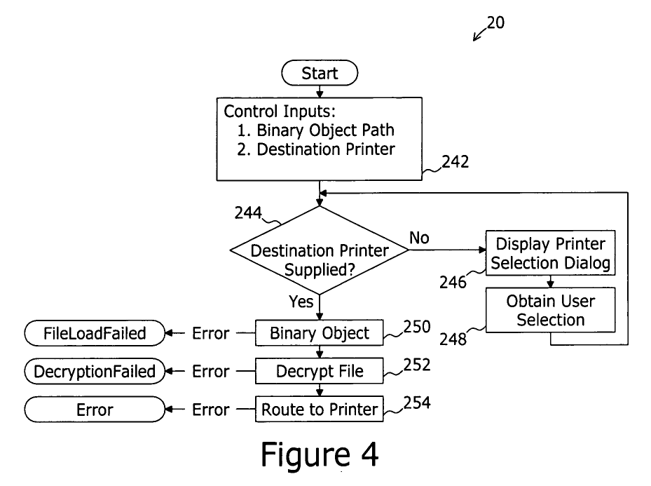

The flow chart of FIG. 4 represents exemplary operation of the print control executable 20. The input information used for launching execution of the print control executable includes a path to the binary object 33 (provided to the browser 18), identification of a selected remote print system 24. Step 242 represents obtaining such input information when supplied.

If the identification of the selected remote print system 24 is not supplied in conjunction with the binary object 33, as represented by step 244, the indication of the destination printer 50 (or virtual print application 23) may be obtained by opening a printer selection dialog window at step 246 and obtaining user selection at step 248.

Step 250 represents loading the binary object 33 into volatile memory, step 252 represents performing decryption to recover the print formatted object 32 represented by the binary object 33 using a pre-determined cipher specification.

Step 254 represents passing the print formatted object 32 to the selected print system 24. If at any of such steps, loading, decryption, or printing fails, an applicable error message may be generated.

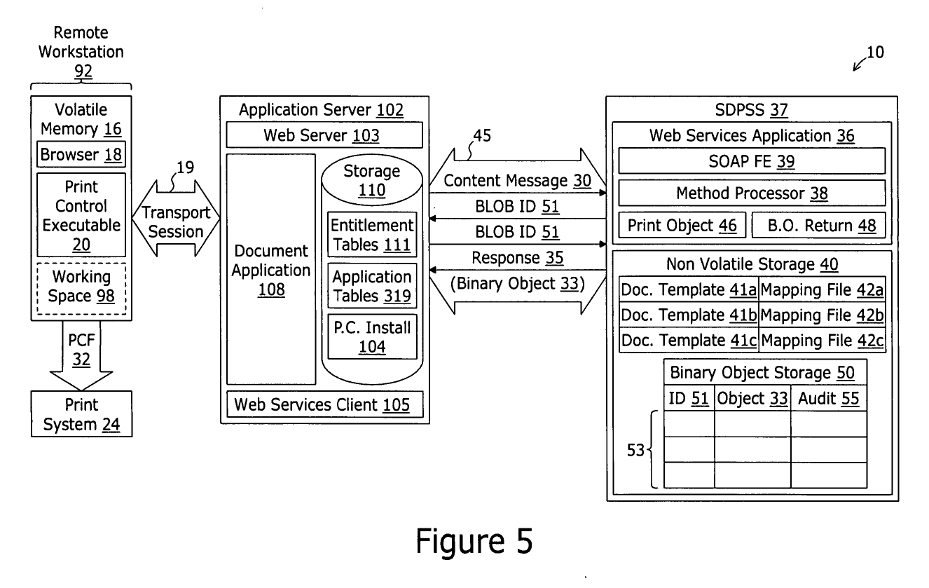

The block diagram of FIG. 5 represents an implementation of the present invention in a system wherein the application server 102 further provides information related to each document set to the secure document printing services server 37 and the secure document printing services server generates each print formatted object 32 from information provided by the application server 102 and document templates 41 and mapping files 42.

The remote workstation 92 includes structure and functions similar to those discussed with respect to the various embodiments of FIGS. 1, 2a, 2b, and 3.

The secure document printing services server 37 includes structure and functions similar to those discussed with respect to the various embodiments of FIGS. 1, 2a, 2b, and 3 and includes a print object 46 which generates each print formatted object 32 from information provided by the application server 102 and document templates 41 and mapping files 42—a plurality of which are stored in non-volatile storage 40.

Each of the BLOB return object 48 and thee print object 46 may be components of a web services application which includes a SOAP front end 39 for maintaining the web services session 45 and a method processor for controlling operation of each of the print object 46 and the BLOB return object 48.

In general, the application server 102 interfaces between the remote workstation 92 and the secure document printing services server 37. The application server 102 comprises a document application 108 which operates in conjunction with both the web server 103 and the web services client 105.

The web server 103 may be structured as a known HTTPS web server for establishing and maintaining a secure transport session 19 with the web browser 18 operating on the remote workstation 92.

The web services client 105 may be structured as a known SOAP front end for communicating SOAP messages between the document application 108 and a SOAP front end 39 of the secure document printing services server 37 using the web services session 45.

The document application 108 includes functions for driving the functionality of the “thin client” browser 18 on the remote workstation 92 through the web server 103 and functions for interfacing with the secure document printing services server 37 through the web services client 105.

A non-volatile storage 110 stores entitlement tables 111, document application tables 319, and a print control installation file 104.

In the exemplary embodiment, the document application 108 is a menu driven application which interacts with the application tables 319 and, in general, provides sequences of web pages to the remote browser 18 thereby enabling a user to authenticate to the document application 108 and navigate menus to execute functions within the user's entitlements. Such functions may include: i) loading document data representing a plurality of documents to be printed into a file within the application tables 319; ii) selecting and approving a one of a plurality of files stored in the application tables 319 for printing at a remote workstation 92 (by a user with document approval entitlements); iii) initiating appropriate web services method calls to the secure document printing services server 37 to transfer an content message 30 representing the selected and approved file to the secure document printing services server 37; iv) obtaining, from the secure document printing services server 37, a unique ID number 51 associated with the binary object 33 (including a representation of a print formatted object 32 representing the document set included in the content message 30) generated by the print command object 46 of the secure document printing services server 37; v) selecting a one of a plurality of binary objects 33 for printing at the remote workstation 92 (by a user with document printing entitlement); vi) generating a return object instruction message 31 to the secure document printing services server 37 including the unique ID number 51 of the selected binary object 33 and obtaining a response message 35 that includes the binary object 33 (as part of a multi part transport message) in response thereto; and vii) transferring the binary object 33 to the remote client 92 through the secure transport session 19 for deciphering and recovery of the print formatted object 32 by the print control executable 20. Further, if a print control executable 20 has not yet been installed on the remote workstation 22, providing the print control installation file 104 to the remote workstation 92.

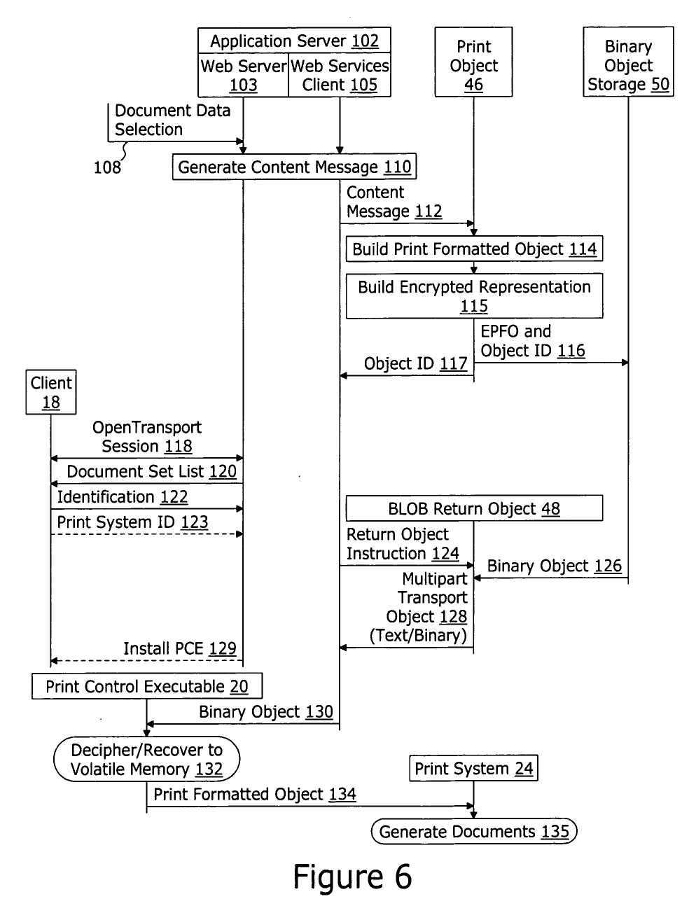

FIG. 6 is a ladder diagram representing exemplary interaction between components of the remote workstation 92, the application server 102, and the secure document printing services server 37 for providing secure document printing services in accordance with this embodiment.

Step 108 represents selection of document data for inclusion in a content message 30. In the exemplary embodiment, a secure transport session may be established between any thin client workstation (including workstation 92), the user of the workstation authenticating to the document application 108 and having document approval entitlements, and such entitled user selecting documents from application tables 319 for inclusion in the content message 30.

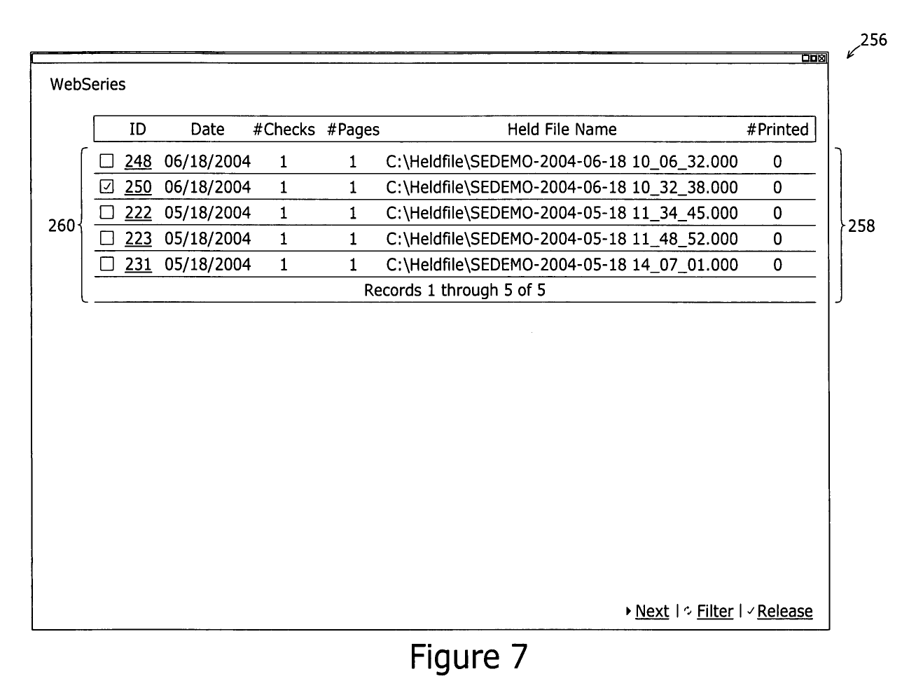

FIG. 7 represents an exemplary web page 256 that the document application 108 may provide to a thin client to enable the user of the thin client to select a one of a plurality of document files (a file containing data elements 34 for inclusion in a content message 30) The web page 256 includes a listing 258 of those document files which the user of the thin client is authorized to approve for printing. In this example, the user would toggle a check box 260 for each approved file. The web page 256 further includes code for transferring an indication of the user's selection back to the document application 43.

Returning to the ladder diagram of FIG. 6 in conjunction with FIG. 5, step 110 represents the document application 108 generating the content message 30. More specifically, step 110 represents extracting the data elements 34 of the document data file corresponding to the user's selection from the application tables 319, converting the document data to tagged data elements conforming to the a predetermined XML content message schema, and packaging the XML message as a SOAP content message 30.

Step 112 represents passing the content message 30 to the secure document printing services server 37 as a web services method call.

Step 114 and step 115 represents the print object 46 building a print command file 32 and encrypting the print formatted object 32 to generate an encrypted representation of the print formatted object 32.

Building the print command file 32 comprises: i) obtaining a document image template 41 which corresponds to the data elements of the content message 30; and ii) populating the data elements into fields of the document image template 41 (using a corresponding mapping file 42) to generate a print formatted object 32.

The document image template 41 comprises a plurality of data fields and a document pattern which defines the relative position for printing of each data field within the document and may further comprise information such as: i) the font and size of each data field; ii) formatting of data for each data field (for example leading and/or trailing characters; and iii) algorithms for generating data for a particular data field from data of other data fields.

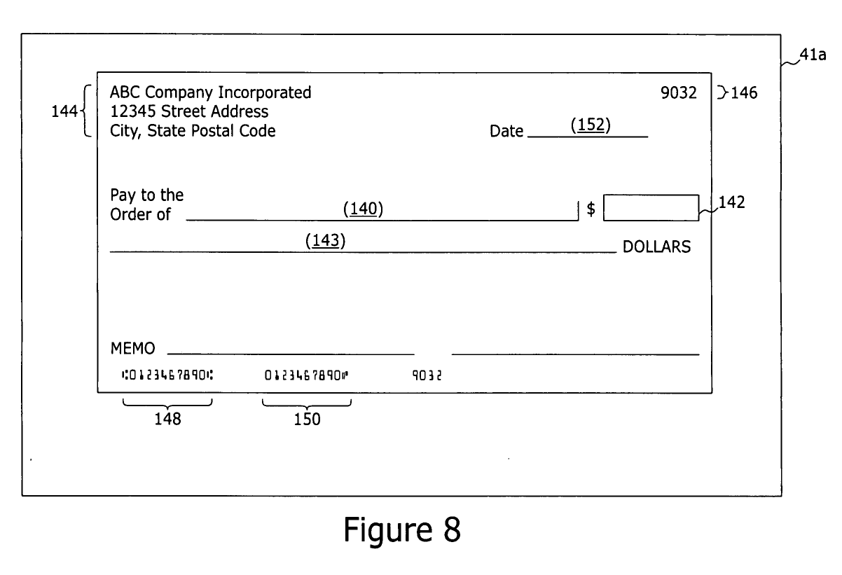

Turning briefly to FIG. 8 an exemplary document image template 41a representing a typical check is shown in a graphic form. Some of the data fields of the check document image template 41a comprise: i) a check number field 146; ii) a date field 152; iii) payer fields 144 (name, address, etc); iv) payee field 140; v) an amount field 142; vi) a legal line field 143 for a script representation of the amount generated from data within amount field 142; vii) a routing number field 148 (designated for printing in MICR font); and viii) an account number field 150 (designated for printing in MICR font). It should be appreciated that a check document may comprise many additional fields, but for brevity of describing an example of the present invention, only the above listed fields will be described.

Returning to FIG. 6 in conjunction with FIG. 5, as previously discussed, encryption of the print formatted object 32 (step 115) may be performed using a predetermined ciphering algorithm which corresponds to a predetermined deciphering algorithm coded into the print control executable 20.

Step 116 represents storing the encrypted representation of print formatted object 32 as a binary object 33 in association with a unique identification number 51 in the binary object storage 50.

Step 117 returning the unique ID number 51 (as a tagged data element of an XML message) to the application server 102.

Step 118 represents the client 18 and the web server 103 opening the secure transport session 19 and verifying the entitlements of the user. As discussed, the secure transport session 19 is an HTTPS session.

Step 120 represents the web server 103 providing the document set listing 27 to the client application 18. As discussed, the document set listing 27 may be a web page that includes a list of each document set represented by a binary object 22 within object storage 50 of the secure document printing services server 37.

Step 122 represents the client application 18 providing identification 29 of a selected document set back to the web server 103. As discussed, the web page including the document set list 27 may include code prompting the user of the remote client 18 to select a document set for printing and, following selection, post the identification 29 of the selected one of the plurality of document sets to the web server 103. Step 122 represents such posting.

Again, in a sub embodiment wherein the print system 24 at which the document set is to be printed (or virtually printed) is selected by the user of client 18, the web page (or a separate web page or dialog box provided through the transport session 19) may be used to obtain user identification of the selected remote print system at which the document set is to be printed. Step 123 represents obtaining identification of the selected remote print system.

Step 124 represents the web services client 105 providing a return object instruction message 31 to the secure document printing services server 37 and the BLOB return object 48 receiving such instruction message 31.

As discussed, the return object instruction message 31 may be an XML message within a SOAP wrapper which includes the an identification number which corresponds to the unique identification number 51 associated with the binary object 33 (stored in the binary object storage 50) that includes the print formatted object 32 representing the selected one of the plurality of document sets. As is typical of an XML message, a predetermined text label is used to label or identify such identification number.

Further, in the sub embodiment wherein the print system 24 at which the document set is to be printed is selected by the user of client 18, identification of the selected remote print system may be included in the return object instruction message 31.

Step 126 represents the BLOB return object 48 retrieving the binary object 33 (which corresponds to the identification number provided in the return object instruction message 31) from the binary storage 50.

Step 128 represents the BLOB return object 48 providing a response message 35 back to the web services client 105. As discussed, response message 35 includes the retrieved binary object 33. The response message 35 may be a multipart transport message that includes both a SOAP object within a root body part and the binary object 33. The multipart transport message may comply with the MIME protocol and include the SOAP object within the root body part and include a predetermined text string identifying the type of file represented by the binary object 33.

Step 130 represents sending the binary object 33 to the print control executable 20 and, in the sub embodiment wherein the print system 24 at which the document set is to be printed is selected by the user of client 18, step 131 represents sending identification of the selected remote print system to the print control executable. Both may be sent in the same multipart transport message.

As discussed, the print control executable 20 may be a system operated by the 10 application server 102 or may be a system operated in conjunction with the client application 18—for example as a browser plug in.

In an implementation wherein the print control executable 20 operates in conjunction with a browser 18 on a remote client workstation 92, if a binary object 33 representing an encrypted print command file 32 is received and the print control executable 20 is not yet installed on the remote client 92, a print control install file 104 may be provided to the remote workstation 92 and the user prompted to download and install the print control executable 20 in the manner typically for downloading and installing “browser plug-ins”. Step 129 represents downloading a print control installation file and installing the print control executable 20 on the workstation 92—if not previously installed.

Box 132 represents the print control executable 20 recovering (and if applicable, deciphering to recover) the print formatted object 32 and, at step 134, passing the print formatted object 32 to the print system 24.

Although the invention has been shown and described with respect to certain exemplary embodiments, it is obvious that equivalents and modifications will occur to others skilled in the art upon the reading and understanding of the specification.

For example, in each of the figures, the application server 102 and the secure document printing services server 37 are shown as distinct servers communicating through a web services session 14 established over a network 12. It is envisioned that the functions of both the application server 102 and the secure document printing services server 37 may be combined on a single hardware server or on multiple hardware servers operating in conjunction with a single database environment. The single database environment may combine, in a single database, the functions of both the non volatile storage 40 of the secure document printing services server 37 and the non volatile storage 110 of the application server 102.

It is envisioned that after reading and understanding the present invention those skilled in the art may envision other processing states, events, and processing steps to further the objectives of the system of the present invention. The present invention includes all such equivalents and modifications, and is limited only by the scope of the following claims.

What is claimed is:

1. A system for generating a document at a remote print system, the system comprising:
a secure print services server comprising a return object and binary storage;
the binary storage storing a plurality of binary objects each in association with a unique identifier, each binary object including a print formatted object representing a document set;
an application server comprising a web server and a web services client,
the web server:
providing a listing of a plurality of document sets to a remote client;
obtaining identification of a selected one of the plurality of document sets;
the web services client exchanging simple object access protocol messages with the secure print services server, the web services client generating a return object instruction, the return object instruction comprising an identification number which corresponds to the unique identification number associated with the binary object including the print formatted object representing the selected one of the plurality of document sets;
the return object of the secure print service server:
receiving the return object instruction; and
providing a response message, the response message including the binary object that is stored in association with the unique identification number that corresponds to the identification number provided in the return object instruction message; and
a print control executable receiving the binary object and passing the print formatted object to the remote print system.

2. The system of claim 1, wherein:
each binary object represents an encrypted representation of a print formatted object representing a document set, the encrypted representation being the result of encrypting the print formatted object using a predetermined cipher specification;
the print control executable further decrypts the encrypted representation of the print formatted object to recover the print formatted object into volatile memory only using a predetermined deciphering specification which corresponds to the predetermined cipher specification.

3. The system of claim 1, wherein
the web server further obtains identification of a selected remote print system to which the print formatted object of the document set is to be transferred;
the web services client includes identification of the selected remote print system in the return object instruction;
the response message further includes identification of the selected remote print system; and
the print control executable extracts identification of the selected remote print system from the response message and passes the print formatted object to the selected remote print system.

4. The system of claim 3, wherein:
each binary object represents an encrypted representation of a print formatted object representing a document set, the encrypted representation being the result of encrypting the print formatted object using a predetermined cipher specification;
the print control executable further decrypts the encrypted representation of the print formatted object to recover the print formatted object into volatile memory only using a predetermined deciphering specification which corresponds to the predetermined cipher specification.

5. The system of claims 1, wherein:
upon receipt of the binary object, the print control executable generates a dialog box to obtain user identification of a selected remote print system; and
upon receipt of user identification of a selected remote print system, the print control executable asses the print formatted object to the selected remote print system.

6. The system of claim 5, wherein:
each binary object represents an encrypted representation of a print formatted object representing a document set, the encrypted representation being the result of encrypting the print formatted object using a predetermined cipher specification;
the print control executable further decrypts the encrypted representation of the print formatted object to recover the print formatted object into volatile memory only using a predetermined deciphering specification which corresponds to the predetermined cipher specification.

7. The system of claim 2, wherein:
the print control executable operates on a remote client to the web server; and
the return object provides the response message to the web services client; and
web server provides the binary object from the response message to the print control executable.

8. The system of claim 7, wherein:
the web server further obtains identification of a selected remote print system to which the print formatted object of the document set is to be transferred;
the web services client includes identification of the selected remote print system in the return object instruction;
the response message further includes identification of the selected remote print system;
the web server provides the identification of the selected remote print system to the print control executable in conjunction with the binary object; and
the print control executable extracts identification of the selected remote print system from the response message and passes the print formatted object to the selected remote print system.

9. The system of claims 7, wherein:
upon receipt of the binary object, the print control executable generates a dialog box to obtain user identification of a selected remote print system; and
upon receipt of user identification of a selected remote print system, the print control executable asses the print formatted object to the selected remote print system.

10. A method for securely generating a document at a remote print system, the method comprising:
storing a plurality of binary objects in a storage of a secure print services server, each binary object:
including a print formatted object representing a document set; and
being stored in association with a unique identifier;
configuring a web server to:
provide a web page to a remote client, the web page listing a plurality of document sets; and
obtain identification of a selected one of the plurality of document sets that is approved for printing;
configuring a web services client to generate a return object instruction to the secure print services server, the return object instruction comprising an identification number which corresponds to the unique identification number associated with the binary object that includes the print formatted object representing the selected one of the plurality of document sets;
configuring a return object of the secure print service server for:
receiving the return object instruction; and
providing a response message, the response message including the binary object that is stored in association with the unique identification number that corresponds to the identification number provided in the return object instruction message; and
configuring a print control executable to receive the binary object and pass the print formatted object to the remote print system.

11. The method of claim 10, wherein:
each binary object represents an encrypted representation of a print formatted object representing a document set, the encrypted representation being the result of encrypting the print formatted object using a predetermined cipher specification; and
the method further comprises configuring the print control executable to decrypts the encrypted representation of the print formatted object to recover the print formatted object into volatile memory only using a predetermined deciphering specification which corresponds to the predetermined cipher specification.

12. The method of claim 10, wherein
the web server further is further configured to obtain identification of a selected remote print system to which the print formatted object of the document set is to be transferred;
the web services client is further configured to include identification of the selected remote print system in the return object instruction;
the response message further includes identification of the selected remote print system; and
the print control executable is further configured to extract identification of the selected remote print system from the response message and pass the print formatted object to the selected remote print system.

13. The method of claim 12, wherein:
each binary object represents an encrypted representation of a print formatted object representing a document set, the encrypted representation being the result of encrypting the print formatted object using a predetermined cipher specification; and
the method further comprises configuring the print control executable to decrypts the encrypted representation of the print formatted object to recover the print formatted object into volatile memory only using a predetermined deciphering specification which corresponds to the predetermined cipher specification.

14. The method of claims 10, wherein the print control executable is further configured to:
upon receipt of the binary object, generate a dialog box to obtain user identification of a selected remote print system; and
upon receipt of user identification of a selected remote print system, pass the print formatted object to the selected remote print system.

15. The method of claim 14, wherein:
each binary object represents an encrypted representation of a print formatted object representing a document set, the encrypted representation being the result of encrypting the print formatted object using a predetermined cipher specification; and
the method further comprises configuring the print control executable to decrypts the encrypted representation of the print formatted object to recover the print formatted object into volatile memory only using a predetermined deciphering specification which corresponds to the predetermined cipher specification.

16. The method system of claim 11, wherein
the print control executable operates on a remote client to the web server; and
the response message is returned to the web services client; and
web server is further configured to provide the binary object from the response message to the print control executable.

17. The method of claim 16, wherein
the web server is further configured to obtain identification of a selected remote print system to which the print formatted object of the document set is to be transferred;
the web services client is further configured to include identification of the selected remote print system in the return object instruction;
the response message further includes identification of the selected remote print system;
the web server is further configured to provide the identification of the selected remote print system to the print control executable in conjunction with the binary object; and
the print control executable is further configured to extract identification of the selected remote print system from the response message and pass the print formatted object to the selected remote print system.

18. The method of claim 16, wherein the print control executable is further configured to:
upon receipt of the binary object, generate a dialog box to obtain user identification of a selected remote print system; and
upon receipt of user identification of a selected remote print system, pass the print formatted object to the selected remote print system.
